(19) United States
(12) Patent Application Publication
(10) Pub. No.: US 2013/0286652 A1
(43) Pub. Date: Oct. 31, 2013

(54) TABLE LAMP

(71) Applicant: HUA-JUNG CHIU, TAOYUAN COUNTY (TW)

(72) Inventor: HUA-JUNG CHIU, TAOYUAN COUNTY (TW)

(73) Assignee: DAVINCI INDUSTRIAL INC., NEW TAIPEI CITY (TW)

(21) Appl. No.: 13/457,380

(22) Filed: Apr. 26, 2012

(51) Int. Cl. F21V 21/26; F21V 13/10

(52) U.S. Cl. 362/285

(57) ABSTRACT

A table lamp is provided, including a base adaptable on a working surface; a lamp post mounted on the base at its lower end; a pivot joint rotatably mounted on the upper end of the lamp post; an adjustable arm pivotably mounted on the upper end of the lamp post through the pivot joint; a lamp shade pivotably mounted on the other end of the adjustable arm including a lighting module; and an elongated driving member arranged substantially along the adjustable arm pivotally connecting the lamp shade and the lamp post. The driving member is configured to maintain an angle of the lamp shade with respect to the working surface when the adjustable arm is pivotally adjusted with respect to the lamppost. Thus, when the adjustable arm pivots vertically and horizontally with respect to the lamp post, the lamp shade can be kept parallel to the working surface.

### BACKGROUND

1. Field of the Instant Disclosure

The instant disclosure relates to a table lamp; in particular, to a table lamp which has a driven structure.

2. Description of Related Art

The lighting fixtures have played a very important role in the modern life for it has brought about much convenience to the human population. Furthermore, the rapid development of the technology has also enhanced the quality of the lighting products, and enabling the lighting products to be more user-friendly. In addition, the feedbacks from the users of the products have also propelled more unique products to be researched and invented.

For instance, a conventional table lamp is adaptable on the table surface to provide simply a lighting purpose. Therefore, in terms of space efficiency, or providing auxiliary light source and other value added functions, there is indeed much room for improvement for the single function of lighting of the conventional table lamps. Therefore, it is deemed a critical issue for the industry to research and provide a new multi-functional lighting fixture to satisfy the requirements.

To address the above issue, the inventors strive via industrial experience and academic research to present the instant disclosure, which can effectively improve the limitation described above.

### SUMMARY OF THE INSTANT DISCLOSURE

The object of the instant disclosure is to provide a table lamp, particularly to a table lamp which has a pivot joint and a driving member. Therefore, when the lamp shade and the driving member are performing a respective motion, the lamp shade can be maintained emitting light in the same direction.

The instant disclosure provides which includes a base adaptable on a working surface; a lamp post mounted on the base at the lower end thereof; a pivot joint rotatably mounted on the upper end of the lamp post; an adjustable arm pivotably mounted on the upper end of the lamp post through the pivot joint including a weighted portion arranged at one end thereof; a lamp shade pivotably mounted on the other end of the adjustable arm including a lighting module; and an elongated driving member arranged substantially along the adjustable arm pivotally connecting the lamp shade and the lamp post, wherein the driving member maintains an angle of the lamp shade with respect to the working surface when the adjustable arm is pivotally adjusted with respect to the lamp post.

Ideally, the weighted portion includes a weight, and the adjustable arm is a hollow rod, and where the weight is arranged in the adjustable arm.

Ideally, the adjustable arm includes a plurality of structural bumps arranged on the inner wall of the adjustable arm, where the outer wall of the weight abuts against the structural bumps.

Ideally, the structural bumps has four protruded portions and a coupling region with a coupling trough formed thereon, where the four protruded portions are arranged in pairs on the inner wall of the adjustable arm.

Ideally, the adjustable arm includes a receiving trough and a receiving hole, where the pivot joint is arranged in the receiving trough, and the ball bearing is arranged in the receiving hole.

Ideally, both the coupling member and the anti-slip plate have a through hole formed respectively therein, and the two through holes are in communication to the receiving hole, and the ball bearing is rotatably arranged between the anti-slip plate and the adjustable arm.

Ideally, the ball bearing abuts against the surfaces defining the through holes and the receiving hole.

Ideally, the lamp post includes a coupling portion, and the base has an engaging hole, the coupling portion of the lamp post is detachable arranged in the engaging hole.

Ideally, the coupling portion is a quick-release structure.

Ideally, the lighting module includes a reflective plate and a light-emitting unit, where the reflective plate and the light-emitting unit are arranged sequentially within the lamp shade, the light-emitting unit and the switch are electrically connected to the circuit board.

Based on the above, the instant disclosure has the following advantages:

The table lamp of the instant disclosure utilizes the pivot joint and the weighted portion to balance the two sides of the adjustable arm. The table lamp further includes the driving member and the rotatable joints to maintain the lamp shade parallel to the working surface when the user is adjusting the lamp shade.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a three-dimensional exploded view of the table lamp according to the instant disclosure;

FIG. 2 shows a three-dimensional exploded view of the base and the lamp post according to the instant disclosure;

FIG. 3 shows a three-dimensional exploded view of the adjustable arm and the pivot joint according to the instant disclosure;

FIG. 3A shows a cross-sectional view of the table lamp according to the instant disclosure;

FIG. 4 shows a three-dimensional view of the lamp shade, the rotatable joints, and the driving member of the table lamp according to the instant disclosure;

FIG. 5 shows a perspective view of the table lamp under operation according to the instant disclosure;

FIG. 5A shows another perspective view of the table lamp under operation according to the instant disclosure.

### DETAILED DESCRIPTION OF THE PREFERRED EMBODIMENTS

Unless stated otherwise, all mentioned quantities are not intended to be limiting.

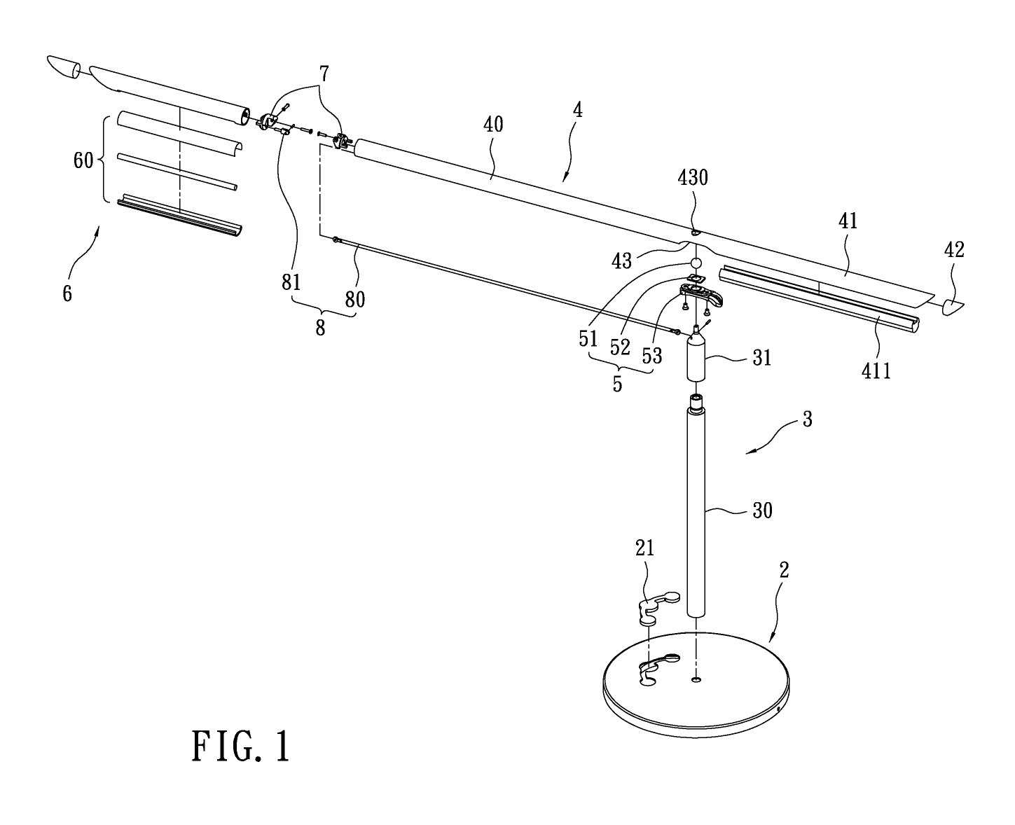

Please refer to FIG. 1 which illustrates a three-dimensional exploded view of a table lamp according to the instant disclosure. The instant disclosure discloses a table lamp which is adaptable on a working surface 1, where the table lamp includes a base 2, a lamp post 3, an adjustable arm 4, a pivot joint 5, a lamp shade 6, a rotatable joint 7, and a driving member 8.

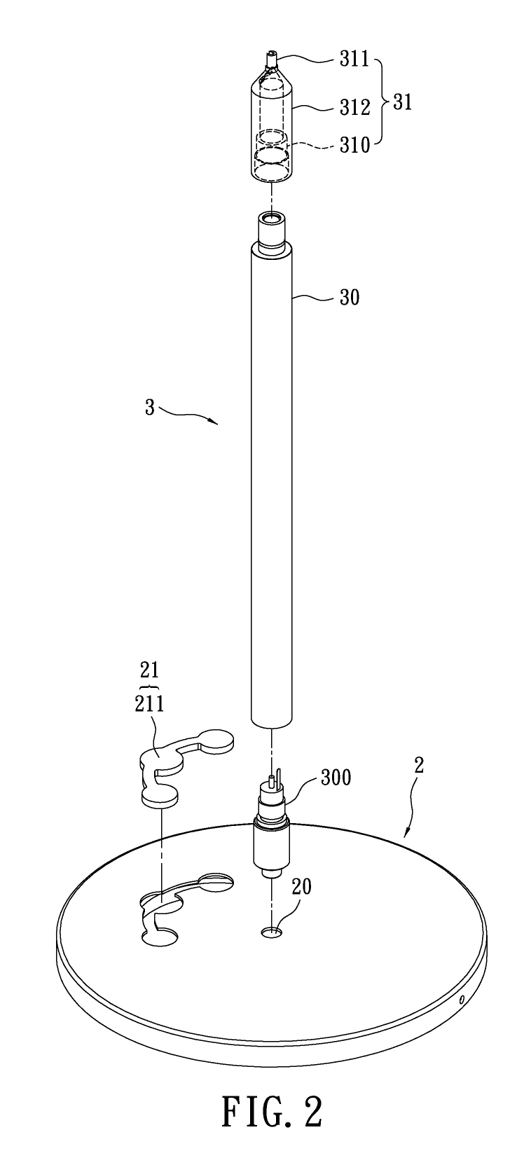

Please refer to FIGS. 1-2, where FIG. 2 shows an exploded view of the base 2 and the lamp post 3 of the instant disclosure. The base 2 can be, but not limited to, a circular base support with a light-adjusting portion 21 arranged thereon. The base 2 can be disposed on the working surface 1, where the base 2 has an engaging hole 20 formed thereon to fasten the lamp post 3.

The light-adjusting portion 21 of the base 2 includes a circuit board (not shown) and a switch 211. The switch 211 of the light-adjusting 21 is connected electrically to the circuit board. The functions of the switch 211, other than controlling the light source of the table lamp, further include the function of controlling the brightness of the lamp shade 6. For the instant disclosure, the brightness of the table lamp can be controlled in five grades.

The lamp post 3 can be, but not limited to, a substantially elongated structure. The lamp post 3 includes a support tube 30 and an assembling member 31. The assembling member 31 includes an assembling hole 310, a protrusion 311 and an assembly body 312 for connection between the assembling hole 310 and the protrusion 311.

The support tube 30 includes a coupling portion 300 for fastening to the base 2. The lamp post 3 and the base 2 are assembled in a detachable manner, and can be connected by mean of screwing, bolting, or using a quick-release structure. The instant disclosure uses the quick-release structure for connection between the base 2 and the lamp post 3, however, this is not restricted thereto.

The other end of the coupling portion 300 is inserted into the assembling hole 310 of the assembling member 31, where the support tube 30 and the assembling member 31 shares the same axis, and the assembling member 31 can rotate with respect to the support tube 30. The protrusion 311 of the assembling member 31 is inserted into the pivot joint 5. In other words, the assembling member 31 is connected to the support tube 30 in a rotatable manner for the lamp shade 6 to be adjustable in different directions.

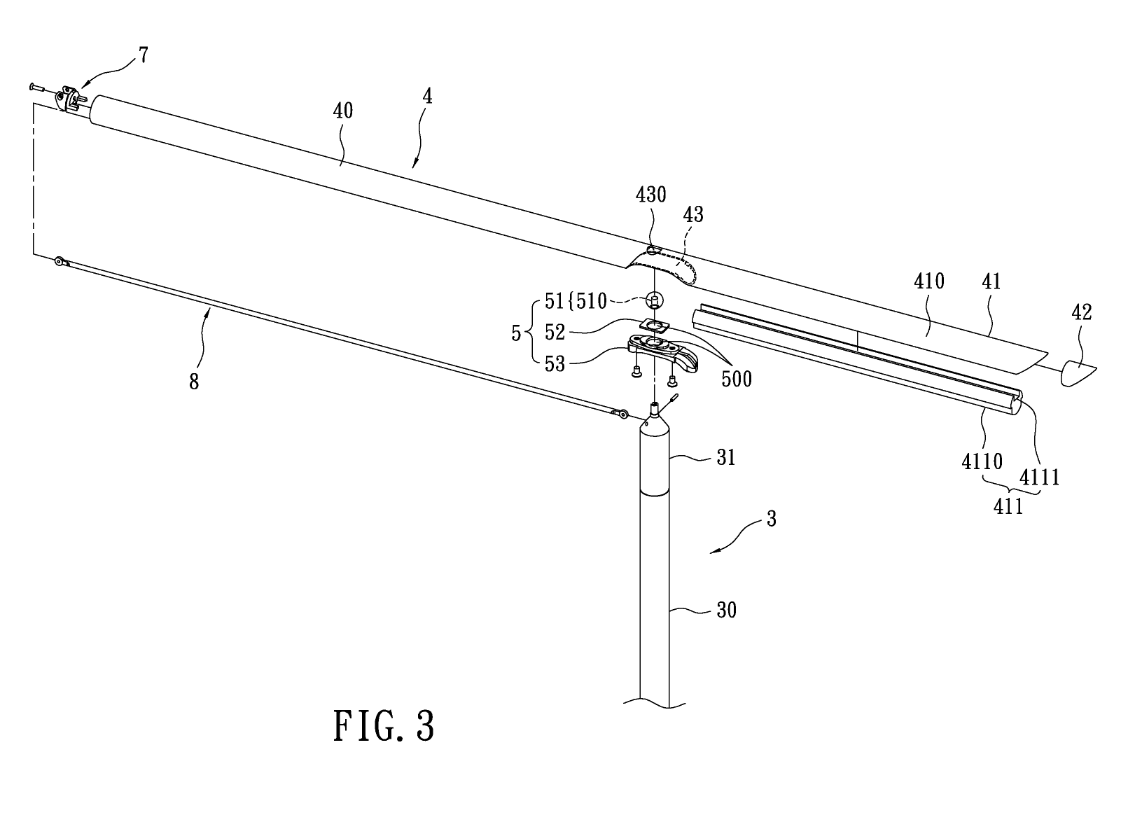

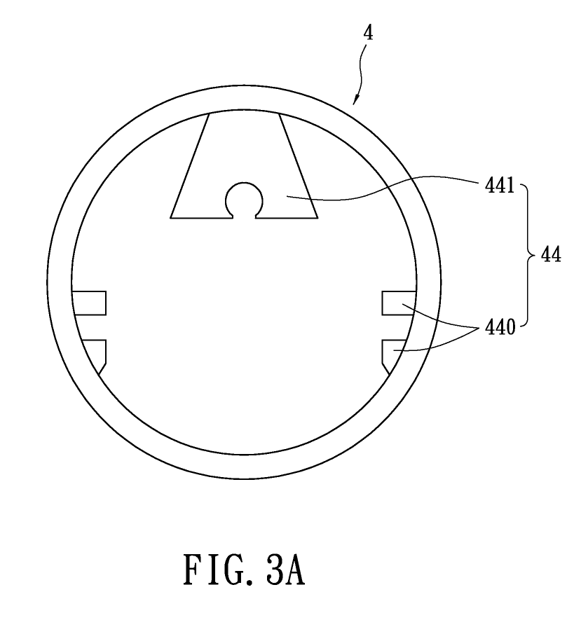

Please refer to FIGS. 3 and 3A, where FIG. 3 shows an exploded view of the adjustable arm 4 and the pivot joint 5 of the table lamp, and FIG. 3A shows a cross-sectional view of the adjustable arm 4 of the table lamp of the instant disclosure. The adjustable arm 4 has a weighted portion 410 and an engaging bump 42, where the weighted portion 410 includes a weight 411 therein. The adjustable arm 4 has a receiving trough 43 formed therein and a receiving hole 430 which is in communication to the receiving trough 43. The adjustable arm 4 of the instant disclosure is a hollow rod which has a plurality of structural bumps 44, however, this is not limited thereto.

The adjustable arm 4 is defined by a front portion 40 and a back portion 41 where the receiving trough 43 is utilized as a divisional point, and the front portion 40 is longer than the back portion 41. Furthermore, the weight 411 is arranged on the back portion 41, the engaging bump 42 is arranged on the opening on the distal end of the back portion 41, and the outer surface of the engaging bump 42 abuts against the inner surface of the adjustable arm 4.

Specifically speaking, the structural bumps 44 in the adjustable arm 4 include four protruded portions 440 and a coupling region 441 with a coupling trough formed thereon. The four protruded portions 440 are arranged in pairs in the inner walls of the adjustable arm 4.

Furthermore, the coupling region 441 is a rectangular prism, where the outer wall of the weight 411 has two side walls 4110 and an engaging trough 4111 which correspond respectively to the protruded portions 440 and the coupling region 441 of the adjustable arm 4. In other words, the side walls 4110 and the engaging trough 4111 abut respectively against the protruded portion 440 and the coupling region 441 of the adjustable arm 4 to restrict the weight 411.

The pivot joint 5 includes a ball bearing 51, an anti-slip plate 52 and a coupling member 53, where the three components are arranged sequentially within the receiving trough 43.

Specifically speaking, the diameter of the receiving hole 430 is smaller than that of the ball bearing 51, such that the ball bearing 51 is exposed from the receiving hole 430 partially and abuts against the inner wall defining the receiving hole 430, and the ball bearing 51 has a connective trough 510 formed therein. Both the coupling member 53 and the anti-slip plate 52 have a through hole 500 formed respectively therein, and the anti-slip plate 52 is a high endurance plate. The assembling member 31 of the lamp post 3 is inserted sequentially through the through holes 500 of the coupling member 53 and the anti-slip plate 52, then the connective trough 510 of the ball bearing 51.

In other words, when the anti-slip plate 52 abuts against the outer surface of the ball bearing 51 to perform the respective motions, the anti-slip plate 52 will provide a frictional force to the ball bearing 51 to slower the respective motions of the anti-slip plate 52 and the ball bearing 51.

The table lamp of the instant disclosure is substantially a balance-like structure where the coupling point between the adjustable arm 4 and the lamp post 3 acts also as the pivoting point, where the two sides thereof are the weighted portion 410 and the lamp shade 6, and the pivot joint 5 is utilized to function in the pivoting point. Furthermore, the weight of the weighted portion 410 is specially designed to balance the front portion 40 and the back portion 41 of the adjustable arm 4. In this way, the lamp shade 6 can be adjusted stably by the users during operation.

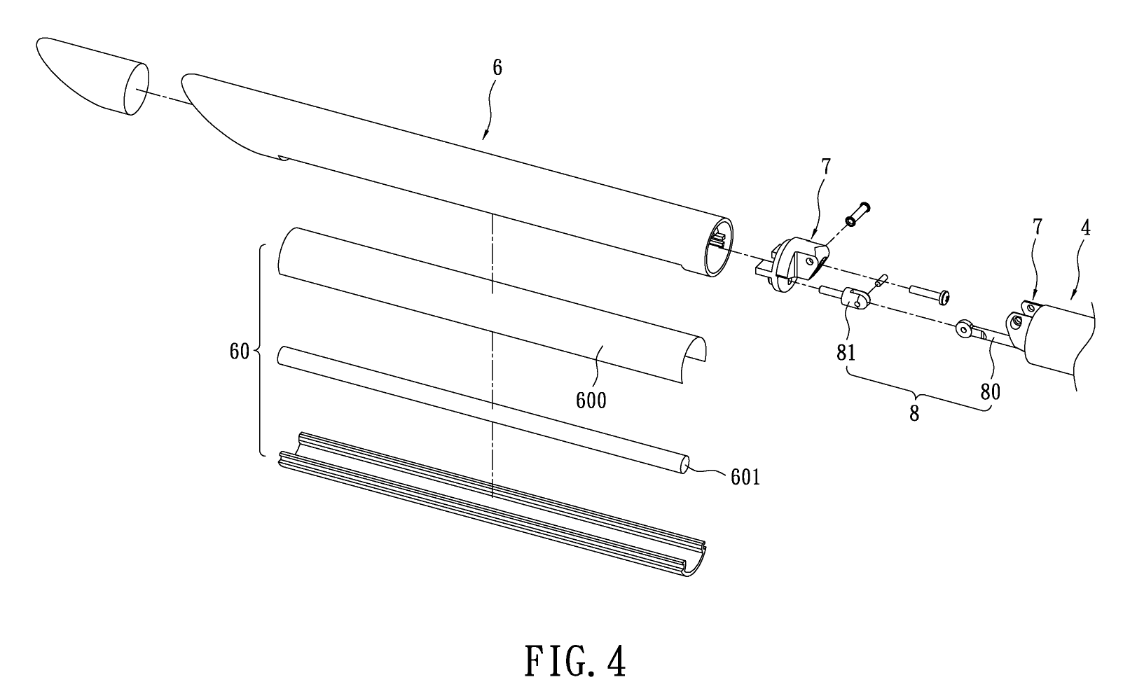

Please refer to FIG. 4 which shows an exploded view of the lamp shade 6, the two rotatable joints 7, and the driving member 8 of the table lamp according to the instant disclosure. The lamp shade 6 includes a lighting module 60, where the lighting module 60 includes a reflective plate 600 and a light-emitting unit 601. The two rotatable joints 7 are mutually pivoted and arranged respectively in the lamp shade 6 and the adjustable arm 4.

The driving member 8 includes a driven rod 80 and a rotatable rod 81 pivoted on one end of the driven rod 80, where the other end of the pivot joint 50 is pivoted to the assembling member 31 (shown in FIG. 3), and the rotatable rod 81 is arranged in the lamp shade 6.

Specifically speaking, the reflective plate 600 and the light-emitting unit 601 are arranged sequentially within the lamp shade 6. The light-emitting unit 601 is connected electrically to the circuit board of the base 2 such that the brightness of the table lamp can be adjusted by the switch 211. For the light-emitting unit 601, the instant embodiment takes the halogen lamp or the light emitting diode for example, however, this is not restricted thereto.

Furthermore, the two rotatable joint 7 are mounted respectively to the lamp shade 6 and the adjustable arm 4, where the two rotatable joint 7 are mutually pivoted. In other words, the lamp shade 6 can be rotated with respect to the adjustable arm 4.

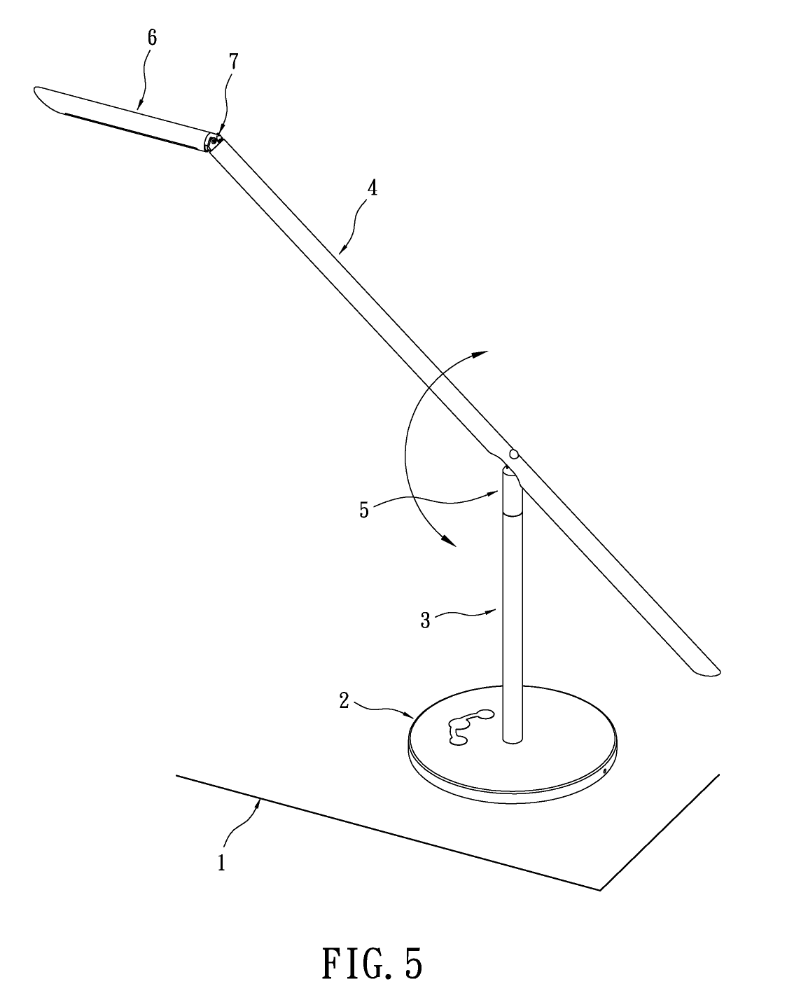

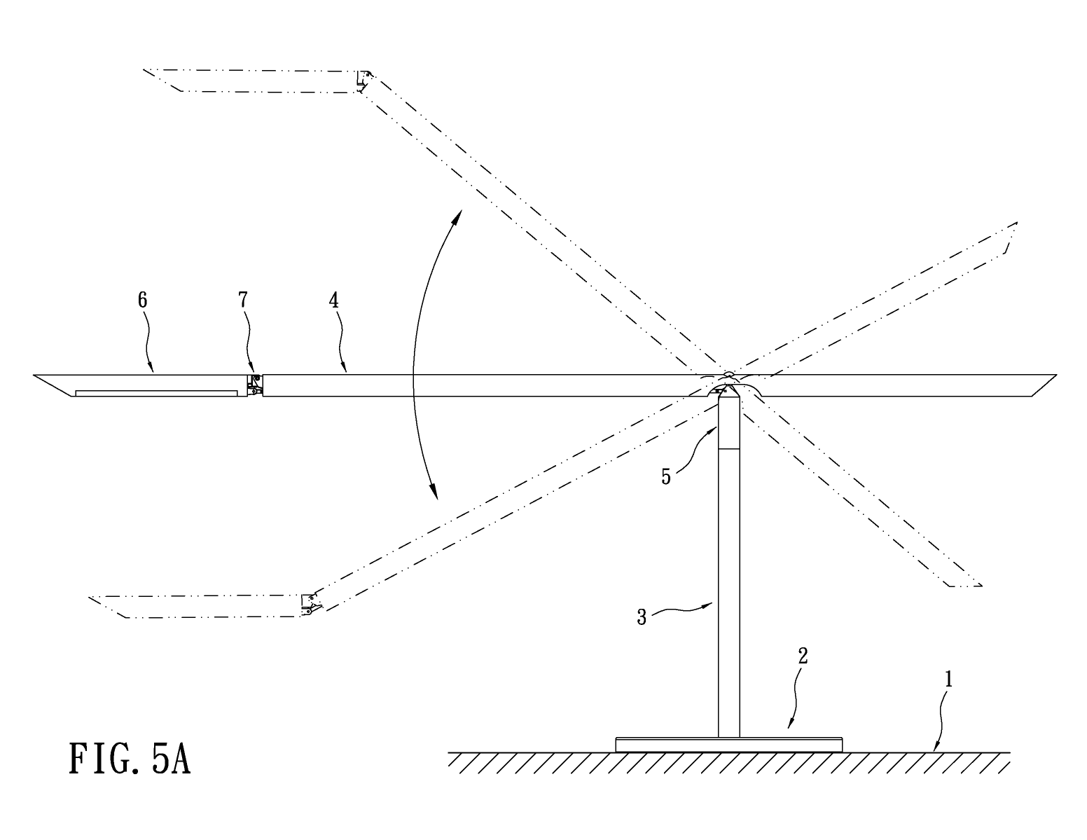

Referring again to FIGS. 1, 5 and 5A, where FIG. 5 and FIG. 5A show a perspective view of the table lamp of the instant disclosure under operation. When the adjustable arm 4 of the lamp utilizes the lamp post 3 as the pivoting point to be adjusted in the vertical direction, the rotatable joint 7 and the lamp shade 6 will be driven to perform the respective motions through the lamp post 3, the adjustable arm 4, the pivot joint 5 and the driving member 8. Therefore, the lighting position of the lamp shade 6 can be maintained parallel to the working surface 1.

Furthermore, the pivot joint 5 of the instant embodiment enables the adjustable arm 4 to be vertically adjustable, and the assembling member 31 enables the adjustable arm 4 to be rotatable from 0° to 360°. Therefore, the lamp shade 6 can be maintained parallel to the working surface 1 even when adjusting the adjustable arm 4.

The table lamp of the instant disclosure utilizes the function of the pivot joint and the driving member for the ball bearing to be rotatably mounted to the adjustable arm. Therefore, the lamp post can perform vertical and horizontal rotations with respect to the adjustable arm. Moreover, the lamp shade can maintain parallel to the working surface when the adjustable arm is motioning. Furthermore, other than disposing the table lamp of the instant disclosure on the table surface, the table lamp can also acts as a floor lamp to brighten up the entire room.

Other than the ball bearing, the anti-slip plate, and the weighted portion of the adjustable arm enable the table lamp of the instant disclosure to be adjustable in a wider angle. The east structure of the instant disclosure has also simplified the manufacturing process which will further reduce the cost.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A table lamp, comprising:
a base adaptable on a working surface;
a lamp post mounted on the base at the lower end thereof;
a pivot joint rotatably mounted on the upper end of the lamp post;
an adjustable arm pivotably mounted on the upper end of the lamp post through the pivot joint including a weighted portion arranged at one end thereof;
a lamp shade pivotably mounted on the other end of the adjustable arm including a lighting module; and
an elongated driving member arranged substantially along the adjustable arm pivotally connecting the lamp shade and the lamp post, wherein the driving member maintains an angle of the lamp shade with respect to the working surface when the adjustable arm is pivotally adjusted with respect to the lamp post.

2. The table lamp of claim 1, wherein the pivot joint comprises:
a ball bearing fixedly mounted on the upper end of the lamp post, the adjustable arm being pivotably supported on the ball bearing; and
a coupling member fixedly disposed on the adjustable arm and rotatably retaining the ball bearing.

3. The table lamp of claim 2, wherein the adjustable arm includes a receiving trough and a receiving hole, wherein the ball bearing is arranged in the receiving hole, wherein the pivot joint is arranged in the receiving trough.

4. The table lamp of claim 3, wherein both the coupling bump and the anti-slip plate have a through hole formed respectively therein, wherein the two through holes communicate to the receiving hole, wherein the ball bearing is arranged between the anti-slip plate and the adjustable arm.

5. The table lamp of claim 4, wherein the ball bearing abuts against the surfaces defining the through holes and the receiving hole.

6. The table lamp of claim 1, wherein the weighted portion includes a weight and the adjustable arm is a hollow rod, and wherein the weight is arranged in the adjustable arm.

7. The table lamp according to claim 6, wherein the adjustable arm includes a plurality of structural bumps arranged on the inner wall of the adjustable arm, where the outer wall of the weight abuts against the structural bumps.

8. The table lamp according to claim 7, wherein the structural bumps have four protruded portions and a coupling region with a coupling trough formed thereon, wherein the four protruded portions are arranged in pairs on the inner wall of the adjustable arm.

9. The table lamp according to claim 1, wherein the lamp post includes a coupling portion, the base has an engaging hole, the coupling portion of the lamp post is detachable arranged in the engaging hole.

10. The table lamp according to claim 9, wherein the coupling portion is a quick-release structure.

11. The table lamp according to claim 10, wherein the lighting module includes a reflective plate and a light-emitting unit, wherein the reflective plate and the light-emitting unit are arranged sequentially within the lamp shade.
